(19) United States
(12) Patent Application Publication
(10) Pub. No.: US 2006/0250342 A1
(43) Pub. Date: Nov. 9, 2006

(54) Display device

(76) Inventors: Yoshihiro Kotani, Chiba (JP); Hidetoshi Kida, Mobara (JP); Kentaro Agata, Mobara (JP); Youzou Nakayasu, Mobara (JP); Hiroshi Watanabe, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/393,781

(22) Filed: Mar. 31, 2006

(30) Foreign Application Priority Data
Apr. 1, 2005 (JP) 2005-105735

(51) Int. Cl. G09G 3/36

(52) U.S. Cl. 345/89

(57) ABSTRACT

The present invention decreases the voltage dependency of a semiconductor resistance element used in a resistance voltage dividing circuit thus preventing the deterioration of display quality of a display image and, at the same time, realizing the reduction of power consumption. In a display device which includes a display element and a drive circuit which drives the display element, the drive circuit includes a semiconductor resistance element, the semiconductor resistance element includes a first conductive impurity region and a second conductive impurity region which is embedded in the first conductive impurity region and functions as a resistance element, the second conductive impurity region includes a first electrode and a second electrode, and a voltage which is applied to the first electrode or the second electrode of the second conductive impurity region is applied to the first conductive impurity region.

### BACKGROUND OF THE INVENTION

1. Field of the Invention

The present invention relates to a display device, and more particularly to a resistance dividing circuit for generating gray scale reference voltages.

2. Description of Related Art

In a liquid crystal display device, gray scale voltages corresponding to display data are selected by a decoder circuit in the inside of a driver, and the gray scale voltages are supplied to a liquid crystal panel so as to allow the liquid crystal panel to display an image. The gray scale voltages are, for example, generated by a resistance voltage dividing circuit which uses ladder resistances in the inside of the driver.

However, when the ladder resistances are used, a direct-current (DC) current is generated and hence, with respect to a digital camera or a portable-use liquid crystal display device which is required to satisfy a strong demand for low power consumption, it is necessary to increase the ladder resistances.

Usual Poly-Si resistance is approximately 15 Ω/sq. and hence the resistance is low. On the other hand, although MOS resistance (forming into DMOS) or high resistance Poly-Si (forming into i-type) are named as the general high resistant element, both resistances require the addition of a mask thus giving rise to a drawback that a cost is pushed up.

To overcome such a drawback, there has been known a method which adopts a semiconductor resistance element (a well resistance element) which can be produced by a conventional process without requiring the addition of a mask (see Japanese Patent Laid-open Hei-8(1996)-288459 (patent document 1) and Japanese Patent Laid-open Hei-11(1999)-214616 (patent document 2)).

### SUMMARY OF THE INVENTION

However, in the conventional semiconductor resistance element, a PN junction is formed among a second conductive well region which functions as a resistance element, a first conductive well region which is arranged around the second conductive well region and constitutes a separation layer, and a first conductive semiconductor substrate.

Accordingly, when a voltage which is applied to an electrode portion of the second conductive well region which functions as the resistance element is elevated, a potential difference between the first conductive well region and the first conductive semiconductor substrate is also elevated thus enlarging a depletion layer which is generated at a PN junction interface.

When the depletion layer is enlarged, a width of the second conductive well region which functions as the resistance element is narrowed in the lateral direction as well as in the longitudinal direction and hence, a resistance value of the second conductive well region is not fixed and is elevated and also depends on the voltage.

Accordingly, when the semiconductor resistance element is used as the voltage dividing resistance of a resistance voltage dividing circuit for generating gray scale voltages in a driver of a liquid crystal display device, there has been a drawback that the gray scale voltages are fluctuated thus degrading display quality of a display image which is displayed on a liquid crystal display panel.

The present invention has been made to overcome the above-mentioned drawback of the related art and it is an object of the present invention to provide a technique which can decrease the voltage dependency of a semiconductor resistance element used in a resistance voltage dividing circuit thus realizing the reduction of power consumption.

The above-mentioned and other object and novel features of the present invention will become apparent based on the description of this specification and attached drawings.

To briefly explain the summary of typical inventions among the inventions disclosed in this specification, they are as follows.

To overcome the above-mentioned drawback, a display device of the present invention includes a display element and a drive circuit which drives the display element, wherein the drive circuit includes a semiconductor resistance element, the semiconductor resistance element includes a first conductive impurity region and a second conductive impurity region which is embedded in the first conductive impurity region and functions as a resistance element, the second conductive impurity region includes a first electrode and a second electrode, and a voltage which is applied to the first electrode or the second electrode of the second conductive impurity region is applied to the first conductive impurity region.

The drive circuit includes a resistance voltage dividing circuit which generates gray scale reference voltages, and at least one of resistance elements which constitute the resistance voltage dividing circuit is constituted of the semiconductor resistance element.

To briefly explain advantageous effects obtained by the typical inventions among the inventions disclosed in this specification, they are as follows.

According to the display device of the present invention, it is possible to reduce the voltage dependency of the semiconductor resistance element.

Accordingly, by using the semiconductor resistance element in a resistance voltage dividing circuit, it is possible to prevent the degradation of image quality of a display image displayed on the display element and to realize the reduction of power consumption.

### BRIEF DESCRIPTION OF THE DRAWING

FIG. 1 is a cross-sectional view of an essential part showing one example of a semiconductor resistance element used in a liquid crystal display module of an embodiment of the present invention;

FIG. 2 is a view showing one example of a layout example of a the semiconductor resistance element shown in FIG. 1;

FIG. 3 is a graph showing a change of sheet resistance of one example of the semiconductor resistance element shown in FIG. 1;

FIG. 4 is a graph showing a resistance change rate of one example of the semiconductor resistance element shown in FIG. 1;

FIG. 5 is a block diagram showing the schematic constitution of a liquid crystal display module of the embodiment of the present invention;

FIG. 6 is a block diagram showing the inner circuit constitution of an LCD driver shown in FIG. 5;

FIG. 7 is a timing chart for explaining a driving method of the liquid crystal display module of the embodiment of the present invention;

FIG. 8 is a circuit diagram showing the inner circuit constitution of the gray scale voltage generating circuit shown in FIG. 6;

FIG. 9 is a cross-sectional view of an essential part showing one example of a conventional semiconductor resistance element;

FIG. 10 is a view showing one example of a layout example of the semiconductor resistance element shown in FIG. 9;

FIG. 11 is a graph showing a change of sheet resistance of one example of the semiconductor resistance element shown in FIG. 9; and

FIG. 12 is a graph showing a resistance change rate of one example of the semiconductor resistance element shown in FIG. 9.

### PREFERRED EMBODIMENTS OF THE PRESENT INVENTION

Embodiments in which the present invention is applied to a liquid crystal display module are explained in detail in conjunction with drawings hereinafter.

Here, in all drawings for explaining the embodiments, parts having identical functions are given same symbols and their repeated explanation is omitted.

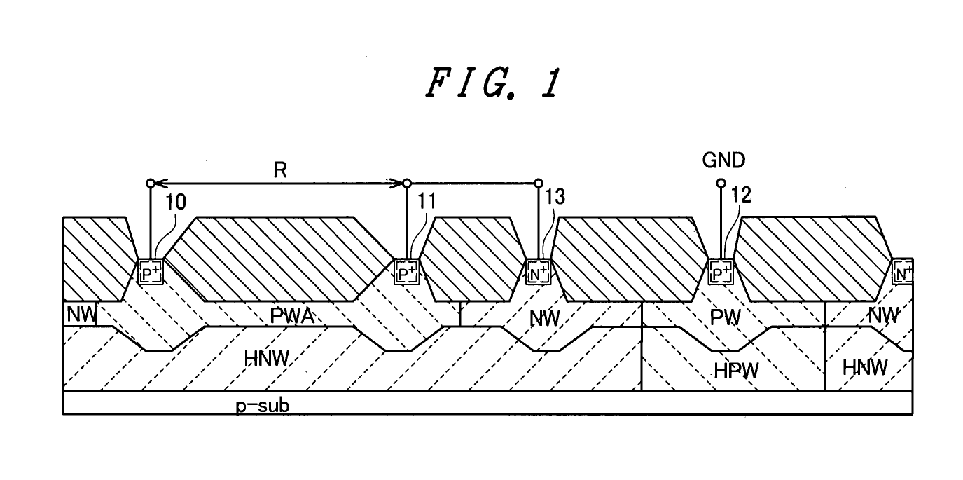

FIG. 1 is a cross-sectional view of an essential part showing one example of a semiconductor resistance element used in a liquid crystal display module of an embodiment of the present invention.

In the drawing, symbol p-sub indicates a p-type semiconductor substrate, symbol PWA indicates a p-type well region (ap-type impurity region) which functions as a resistance element, symbol NW indicates an n-type well region (an n-type impurity region), symbol HNW indicates an n-type well region which is formed deeper than the n-type well region (NW), symbol PW indicates a p-type well region which constitutes a separation layer, symbol HPW indicates a p-type well region which constitutes a separation layer and is formed deeper than the p-type well region PW.

Numerals 10, 11, 12, 13 indicate electrode portions, wherein a reference voltage (GND) is applied to the p-type well region (PW) by way of the electrode portion 12.

In the semiconductor resistance element shown in FIG. 1, the p-type well region (PWA) which functions as the resistance element is formed in a state that the p-type well region (PWA) is embedded in the n-type well regions (NW, HNW). Further, the electrode portion 13 which is formed in the n-type well regions (NW, HNW) and the electrode portion 11 which is formed in the p-type well region (PWA) are electrically connected with each other, and a voltage which is applied to the electrode portion 11 formed in the p-type well region (PWA) is applied to the n-type well regions (NW, HNW).

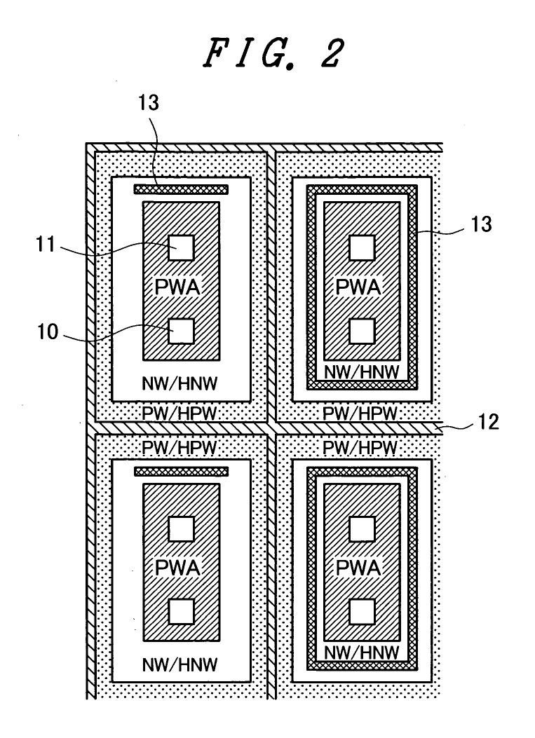

Assuming a voltage which is applied to the electrode portion 10 of the p-type well region (PWA) as V1 and a voltage which is applied to the electrode portion 11 as V2, in the case shown in FIG. 1, the relationship V1<V2 is established. One example of a layout example of the semiconductor resistance element shown in FIG. 1 is shown in FIG. 2.

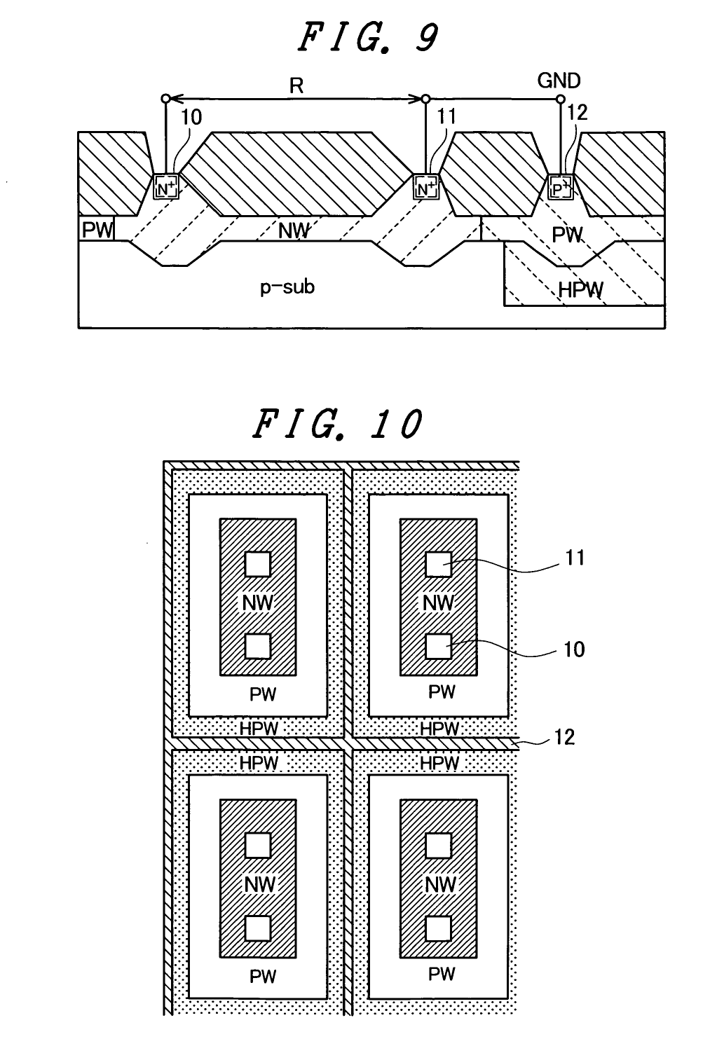

FIG. 9 is a cross-sectional view of an essential part showing one example of a conventional semiconductor resistance element.

In the drawing, symbol p-sub indicates a p-type semiconductor substrate, symbol NW indicates an n-type well region (an n-type impurity region) which constitutes a resistance element, symbol PW indicates a p-type well region which constitutes a separation layer, and symbol HPW indicates a p-type well region which constitutes a separation layer and is formed deeper than the p-type well region PW.

Numerals 10, 11, 12 indicate electrode portions, wherein a reference voltage (GND) is applied to the p-type well region (PW) byway of the electrode portion 12. One example of a layout example of the semiconductor resistance element shown in FIG. 9 is shown in FIG. 10.

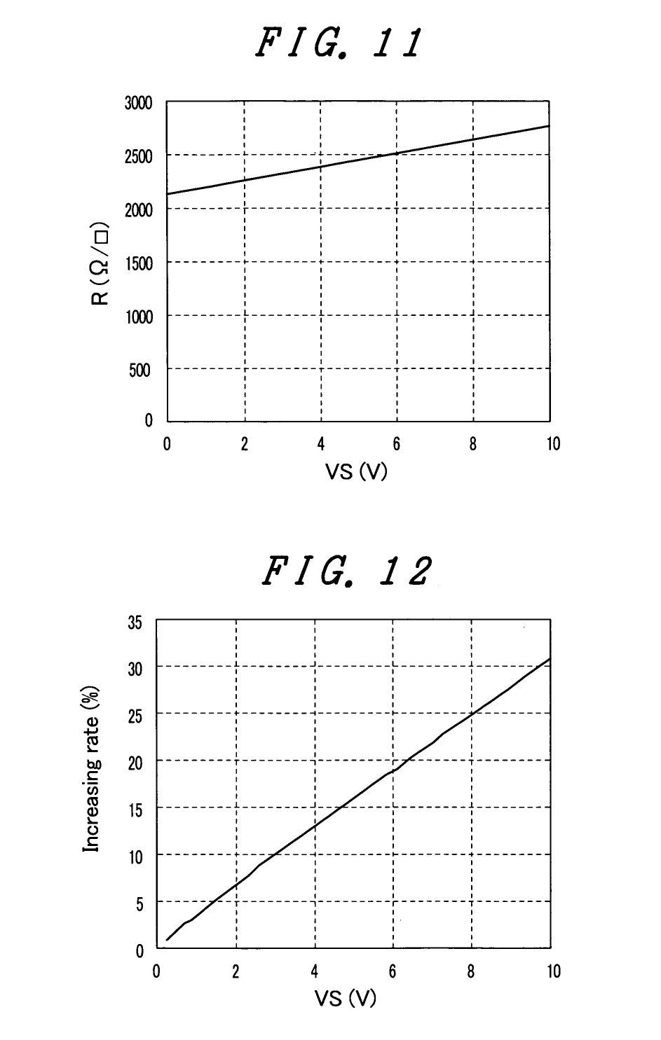

FIG. 11 is a graph showing a change of sheet resistance of one example of the semiconductor resistance element shown in FIG. 9, and FIG. 12 is a graph showing a resistance change rate of one example of the semiconductor resistance element shown in FIG. 9.

The graphs shown in FIG. 11 and FIG. 12 show the change of the sheet resistance and the resistance change rate when a potential difference between the electrode portion 10 and the electrode portion 11 is set to the fixed value of 3V and one-side voltage is swept.

In the semiconductor resistance element shown in FIG. 9, between the n-type well region (NW) which functions as the resistance element and the p-type well region (PW) which constitutes the separation layer and is arranged around the n-type well region (NW) as well as between the n-type well region (NW) and the p-type substrate (p-sub), a PN junction is formed.

Accordingly, when the voltage applied to the electrode portions (10, 11) is elevated, the potential difference between the p-type well region (PW) and the p-type substrate (p-sub) is also elevated and hence, a depletion layer which is generated in a PN junction interface is enlarged.

When the depletion layer is enlarged, a width of the n-type well region (NW) is narrowed in the lateral direction as well as in the longitudinal direction and hence, as shown in FIG. 11 and FIG. 12 a resistance value of a n-type well region (NW) is not fixed and is elevated, and also depends on the voltage.

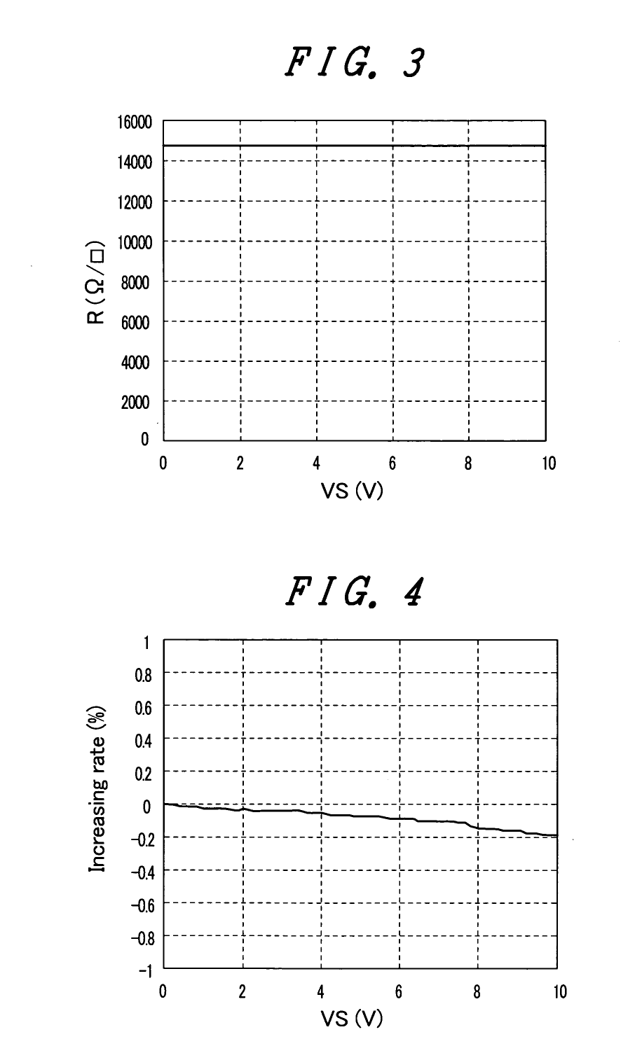

FIG. 3 is a graph showing a change of sheet resistance of one example of the semiconductor resistance element shown in FIG. 1, and FIG. 4 is a graph showing a resistance change rate of one example of the semiconductor resistance element shown in FIG. 1.

The graphs shown in FIG. 3 and FIG. 4 show the change of the sheet resistance and the resistance change rate when a potential difference between the electrode portion 10 and the electrode portion 11 is set to the fixed value of 3V and a voltage which is applied to the electrode portion 11 is swept.

In the semiconductor resistance element shown in FIG. 1, between the p-type well region (PWA) which functions as a resistance element and the n-type well regions (NW, HNW) which are arranged around the p-type well region (PWA), a PN junction is formed. However, in case of the semiconductor resistance element shown in FIG. 1, the p-type well region (PWA) and the n-type well regions (NW, HNW) which are arranged around the p-type well regions (PWA) assume the voltage which is applied to the electrode portion 11 which is formed in the p-type well region (PWA) and hence, even when the voltage applied to the electrode portions (10, 11) is elevated, there is no possibility that a depletion layer which is generated in a PN junction interface is enlarged.

Accordingly, as shown in FIG. 3 and FIG. 4, the resistance value of the p-type well region (PWA) does not depend on the voltage and assumes a fixed value.

Further, since the p-type well region (PWA) is formed in the inside of the n-type well region (HNW), it is possible to obtain the element which has the extremely high resistance. Further, this resistance value can be varied in response to the concentration of impurities in the p-type well region (PWA) or the n-type well regions (HNW).

Further, the n-type well region (HNW) and the p-type well region (HPW) are indispensable as well regions for forming a high dielectric strength MOS transistor in a driver for driving a liquid crystal display panel for a digital camera, for example, and hence, these well regions can be manufactured by directly using a conventional process without modification.

In the semiconductor resistance element shown in FIG. 1, the p-type well region (PWA) which functions as the resistance element is used and hence, it is possible to use the n-type well region as the resistance element.

In this case, it is necessary to use the p-type well region as the well region which is arranged around the n-type well region which functions as the resistance element and in which the n-type well region is embedded.

Further, assuming the voltage which is applied to the electrode portion 10 of the n-type well region as V1 and the voltage which is applied to the electrode portion 11 of the n-type well region as V2 (V1>V2), the electrode portion 13 which is formed in the p-type well region and the electrode portion 11 which is formed in the n-type well region are electrically connected with each other, and the voltage V2 is applied to the p-type well region.

Here, in the above-mentioned patent document 2 (Japanese Patent Laid-open Hei-11(1999)-214616), there exists the description “an embedded impurity region dedicated to a resistance element which has a second conductive type and is held at a predetermined potential is provided between a first conductive resistance impurity region which determines a resistance value of the resistance element and a substrate region of a semiconductor substrate” and the description “a ground potential (GND) or a power source voltage (VDD) is applied as the predetermined potential which is applied to the embedded impurity region dedicated to the resistance element”.

However, the applying of the ground potential (GND) to the embedded impurity region dedicated to the resistance element is substantially equivalent to the semiconductor resistance element shown in the above-mentioned FIG. 9 and hence, there arises a drawback similar to the drawback that the previously-mentioned semiconductor resistance element shown in FIG. 9 has. Further, the applying of the power source voltage (VDD) to the embedded impurity region dedicated to the resistance element biases the PN junction in the forward direction and hence, the resistance value is decreased.

In this manner, in the above-mentioned patent document 2, “the semiconductor resistance element includes a first conductive impurity region and a second conductive impurity region which is embedded in the first conductive impurity region and functions as a resistance element, wherein a voltage which is applied to the first electrode or the second electrode of the second conductive impurity region is applied to the first conductive impurity region” is not disclosed.

The semiconductor resistance element shown in FIG. 1 is used as the voltage dividing resistance of the resistance voltage dividing circuit in the inside of the driver of the liquid crystal display module.

Hereinafter, the liquid crystal display module of the embodiment of the present invention is explained.

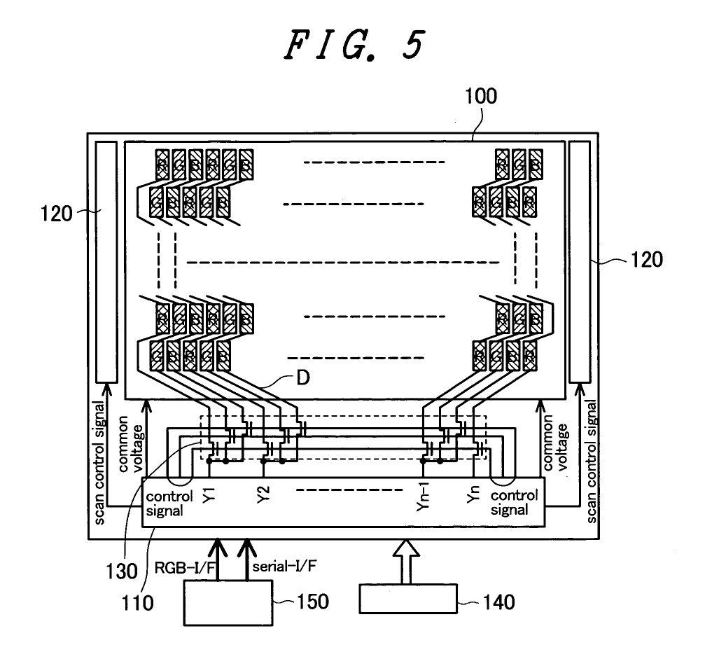

FIG. 5 is a block diagram showing the schematic constitution of the liquid crystal display module of the embodiment of the present invention.

The liquid crystal display module of this embodiment is a TFT (Thin Film Transistor) liquid crystal display module which uses poly-silicon in the semiconductor layer of the thin film transistor (TFT).

In the drawing, numeral 100 indicates a TFT pixel part, numeral 110 indicates a LCD driver, numeral 120 indicates a scanning circuit, numeral 130 indicates a RGB changeover switch, numeral 140 indicates a power source circuit, and numeral 150 indicates a body side of a digital camera.

The TFT pixel part 100 includes a plurality of pixels which is arranged in a matrix array, a plurality of video lines (also referred to as drain lines) D which supplies a video signal voltage to respective pixels, and scanning lines (also referred to as gate lines: not shown in the drawing) which supply a scanning signal to the respective pixels.

Each pixel includes an active element (not shown in the drawing), wherein the active element is connected between the video line (D) and the pixel electrode, and a gate thereof is connected to the scanning line. Further, the pixel includes a common electrode which faces the pixel electrode, and a liquid crystal layer is interposed between the pixel electrode and the common electrode.

Here, the constitution of the pixel is equal to the constitution of a well-known pixel and hence, the detailed explanation of the constitution of the pixel is omitted.

Further, the scanning circuit 120 and the RGB changeover switch 130 shown in FIG. 5 are circuits arranged in the inside of the liquid crystal display panel, wherein these circuits are constituted of thin film transistors which use poly-silicon as the semiconductor layer in the same manner as the active element, and these thin film transistors are formed simultaneously with these active elements.

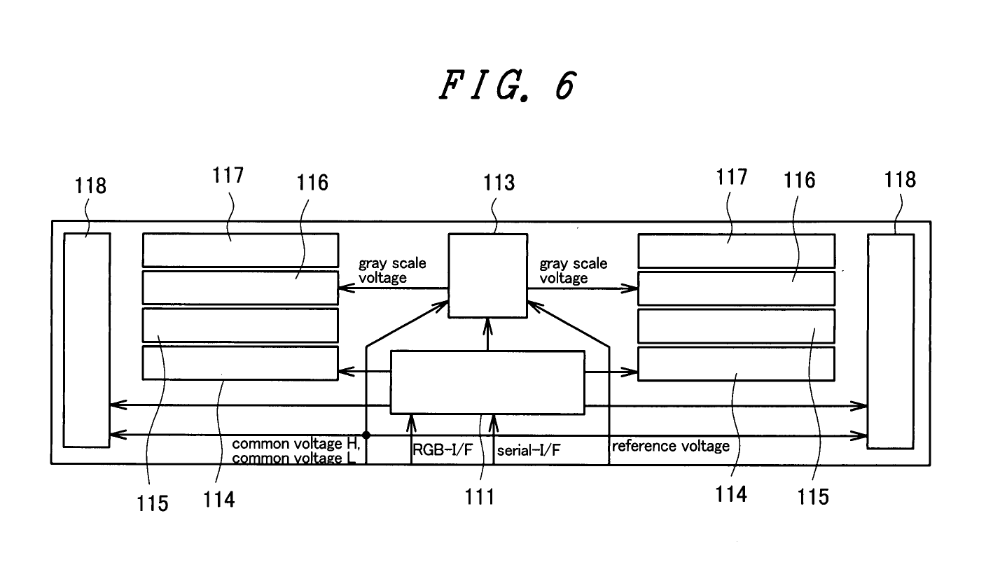

FIG. 6 is a block diagram showing the internal circuit constitution of the LCD driver 110 shown in FIG. 5.

In the drawing, numeral 111 indicates a logic part, numeral 113 indicates a gray scale voltage generating circuit, numeral 114 indicates a shift register circuit, numeral 115 indicates a latch circuit, numeral 116 indicates a decoder circuit, numeral 117 indicates an output amplifying circuit, and numeral 118 indicates a panel integrated circuit control circuit.

The gray scale voltage generating circuit 113 generates, for example, gray scale voltages of 64 gray scales using a reference voltage which is inputted from a power source circuit 140, a high-potential-side voltage which is applied to the common electrode (a VCOM (common voltage) H), and a low-potential-side voltage which is applied to the common electrode (a VCOM (common voltage) L). Here, the power source circuit 140 inputs power source voltages for respective circuits in the inside of the LCD driver 110 to the LCD driver 110.

To the LCD driver 110, display data is inputted from a body side 150 of a digital camera via a RGB interface or a serial interface.

The display data which is inputted to the LCD driver 110 from the body side 150 of the digital camera via the serial interface or the RGB interface is inputted to the logic part 111 and, thereafter, is inputted to the latch circuit 115.

The shift register circuit 114 sequentially outputs a shift clock in response to a clock signal from the logic part 111.

The latch circuit 115 sequentially latches the display data in conformity with shift clocks outputted from the shift register circuit 114.

The display data which is latched by the latch circuit 115 is inputted to the decoder circuit 116, and a gray scale voltage corresponding to the latched display data is selected in the decoder circuit 116.

The gray scale voltage outputted from the decoder circuit 116 has an electric current thereof amplified by the output amplifying circuit 117 and is outputted from output terminals (Y1, Y2 to Yn).

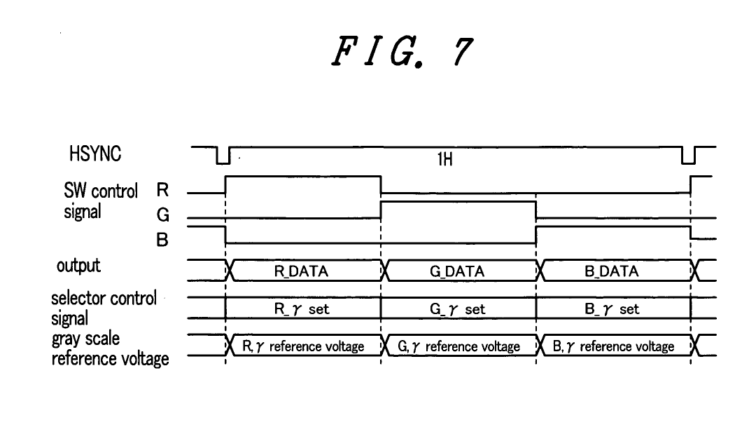

Further, in this embodiment, as shown in FIG. 7, during 1 horizontal scanning time, firstly, a gray scale voltage corresponding to display data of red (R) is outputted from the LCD driver 110. Subsequently, a gray scale voltage corresponding to display data of green (G) is outputted from the LCD driver 110. Finally, a gray scale voltage corresponding to display data of blue (B) is outputted from the LCD driver 110.

Accordingly, the RGB changeover switch 130, when the gray scale voltage corresponding to the display data of red (R) is outputted from the LCD driver 110, connects the output terminals (Y1, Y2 to Yn) of the LCD driver 110 to the video signal lines (D) which are connected to the pixels of red (R). The RGB changeover switch 130, when the gray scale voltage corresponding to the display data of green (G) is outputted from the LCD driver 110, connects the output terminals (Y1, Y2 to Yn) of the LCD driver 110 to the video signal lines (D) which are connected to the pixels of green (G). The RGB changeover switch 130, when the gray scale voltage corresponding to the display data of blue (B) is outputted from the LCD driver 110, connects the output terminals (Y1, Y2 to Yn) of the LCD driver 110 to the video signal lines (D) which are connected to the pixels of blue (B).

On the other hand, the panel-integrated-circuit control circuit 118 outputs a scanning circuit control signal to the scanning circuit 120 such that the scanning lines are sequentially selected for every 1 horizontal scanning time.

The scanning circuit 120 sequentially selects the scanning lines and outputs a scanning signal voltage to the scanning lines. That is, the scanning circuit 120 outputs a signal which selects the scanning lines in order from above in the drawing during 1 horizontal scanning time. Accordingly, an image is displayed on the TFT pixel part 100.

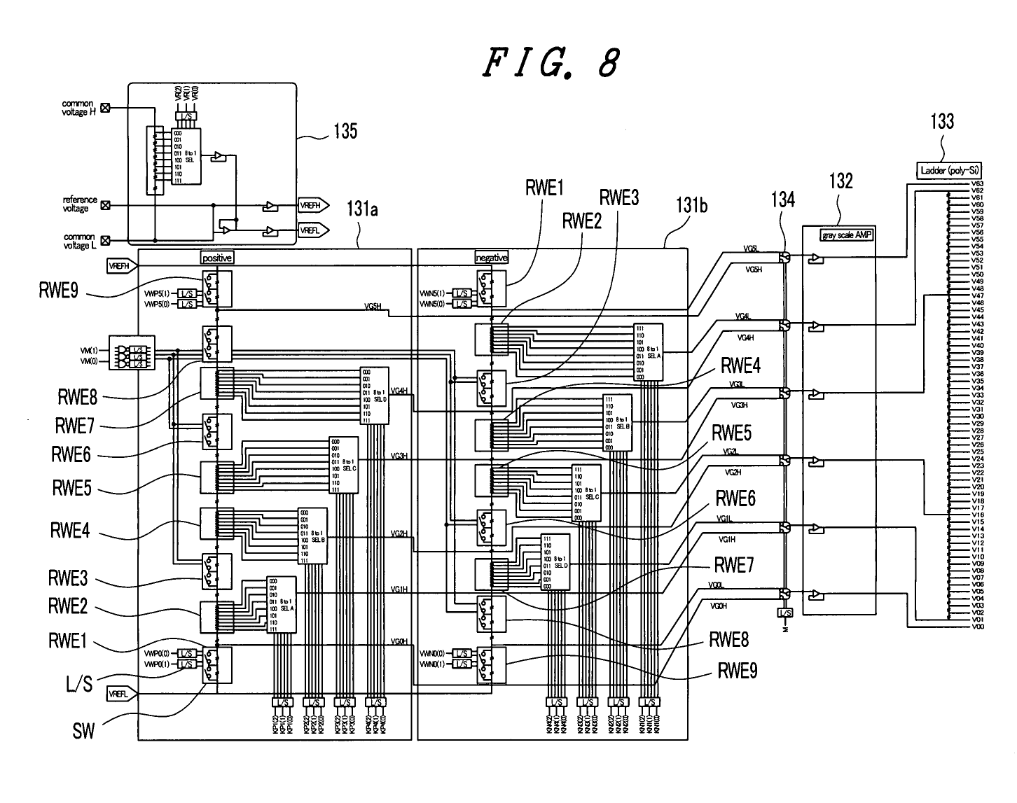

FIG. 8 is a circuit diagram showing the internal circuit constitution of the gray scale voltage generating circuit 113 shown in FIG. 6. In the drawing, symbol L/S indicates a level shift circuit and symbols SELA, SELB, SELC, SELD indicate selectors.

In the circuit shown in FIG. 8, using resistance voltage dividing circuits (131a, 131b), a voltage between a high-voltage reference voltage (VREFH) and a low-voltage reference voltage (VREFL) is divided thus generating gray scale reference voltages of 6 gray scales.

Here, the high-voltage reference voltage (VREFH) and the low-voltage reference voltage (VREFL) are generated in the reference voltage generating circuit 135 using the reference voltage which is inputted from the power source circuit 140, a high-potential-side voltage (VCOM (common voltage) H) which is applied to the common electrode, and a low-potential-side voltage (VCOM (common voltage) L) which is applied to the common electrode.

The gray scale reference voltages of 6 gray scales are, after having electric currents thereof amplified by the amplifying circuit 132, inputted to a gray scale voltage generating ladder circuit (a so-called resistance voltage dividing circuit) 133. The gray scale voltage generating ladder circuit 133 divides voltages between the respective gray scale reference voltages thus generating gray scale voltages of 64 gray scales (V00 to V63). Here, Poly-Si resistances are used in the gray scale voltage generating ladder circuit 133.

In general, in the driving method of the liquid crystal display device, AC driving is performed so as to prevent a DC current from being applied to the liquid crystal layer.

In this embodiment, as such a AC driving method, a common inversion method is adopted. In the common inversion method, to apply the low-potential-side voltage (the VCOM (common voltage) L) to the common electrode, it is necessary to apply the positive-polarity gray scale voltage to the pixel electrodes (that is, the video lines (D)), while to apply the high-potential-side voltage (the VCOM (common voltage) H) to the common electrode, it is necessary to apply the negative-polarity gray scale voltage to the pixel electrodes (that is, the video lines (D)).

Accordingly, in the circuit shown in FIG. 8, as the resistance voltage dividing circuit for generating the gray scale reference voltages, two resistance voltage dividing circuits, that is, the positive-polarity voltage dividing circuit 131a for generating the gray scale reference voltages (VG0H to VG5H) of 6 gray scales of positive polarity and the negative-polarity resistance voltage dividing circuit 131b for generating the gray scale reference voltages (VG0L to VG5L) of 6 gray scales of negative polarity are used.

The gray scale reference voltages which are outputted from the positive-polarity resistance voltage dividing circuit 131a and the negative-polarity resistance voltage dividing circuit 131b are inputted to the switching circuit 134 and, in response to the AC signal (M), either one of the gray scale reference voltage of the positive polarity and the gray scale reference voltage of negative polarity is selected and is inputted to the amplifying circuit 132.

Here, all or at least one of respective voltage dividing resistances (RWE1 to RWE9) of the positive-polarity resistance voltage dividing circuit 131a and the negative-polarity resistance voltage dividing circuit 131b are constituted of the semiconductor resistance element shown in FIG. 1.

Among the respective voltage dividing resistances of the positive-polarity resistance voltage dividing circuit 131a and the negative-polarity resistance voltage dividing circuit 131b, each of the voltage dividing resistances RWE1, RWE3, RWE6, RWE8, RW9 is constituted of a series circuit in which a plurality of (two in FIG. 8) semiconductor resistance elements (the semiconductor resistance elements shown in FIG. 1) to which switching elements (SW) are connected is connected in series.

Then, the voltage dividing resistances RWE1, RWE9 can vary resistance values thereof in response to values of signals VWP5[1], VWP5[0], VWP0[1], VWP0[0], VWN5[1], VWN5[0], VWN0[1], VWN0[0] and hence, a white/black level of the display image and amplitude of the liquid crystal applied voltage can be varied whereby a contrast of a display image can be arbitrarily adjusted.

Further, among the respective voltage dividing resistances of the positive-polarity resistance voltage dividing circuit 131a and the negative-polarity resistance voltage dividing circuit 131b, each of the voltage dividing resistances RWE2, RWE4, RWE5, RWE7 is constituted of a series circuit in which a plurality of (seven in FIG. 8) semiconductor resistance elements (the semiconductor resistance elements shown in FIG. 1) is connected in series.

Outputs of the respective semiconductor resistance elements having the voltage dividing resistances RWE2, RWE4, RWE5, RWE7 are imputed to the selectors (SELA to SWLD).

Here, the voltage dividing resistances RWE3, RWE6, RWE8 can vary resistance values thereof in response to values of signals VM[1], VM[0] and, at the same time, the selectors (SELA to SWLD) can select predetermined voltage values based on signals KP4[2] to KP1[2], KP4[1] to KP1[1], KP4[0] to KP1[0], KN4[2] to KN1[2], KN4[1] to KN1[1], KN4[0] to KN1[0].

Accordingly, it is possible to vary voltage levels of the gray scale reference voltages (VG0H to VG5H, VG0L to VG5L) and hence, the respective gamma (y) characteristics of red (R), green (G), blue (B) can be individually adjusted.

Accordingly, as shown in a timing chart of FIG. 7, when the display data of red (R), the display data of green (G) and the display data of blue (B) are outputted from the LCD driver 110 by time-division processing during 1 horizontal scanning time, by changing over the selectors in conformity with the output timings of RGB, it is possible to adjust the gamma (γ) characteristics of red (R), green (G), blue (B) to tones in conformity with the liquid crystal display panel.

Here, in the above-mentioned description, although the explanation has been made with respect to the embodiment in which the present invention is applied to the liquid crystal display module, it is needless to say that the present invention is not limited to such an embodiment and the present invention is applicable to other display device such as an EL display device.

Although the embodiment made by inventors of the present invention has been explained specifically in conjunction with the embodiment, it is needless to say that the present invention is not limited to the embodiment and various modifications can be made without departing from the gist of the present invention.

What is claimed is:

1. A display device comprising:
a display element: and
a drive circuit which drives the display element, the drive circuit including a semiconductor resistance element, wherein
the semiconductor resistance element includes a first conductive impurity region and a second conductive impurity region which is embedded in the first conductive impurity region and functions as a resistance element,
the second conductive impurity region includes a first electrode and a second electrode, and
a voltage which is applied to the first electrode or the second electrode of the second conductive impurity region is applied to the first conductive impurity region.

2. A display device according to claim 1, wherein
the first conductive impurity region is a p-type impurity region,
a second conductive impurity region is an n-type impurity region,
assuming a voltage applied to the first electrode of the second conductive impurity region as V1 and a voltage which is applied to the second electrode of the second conductive impurity region as V2, the relationship V1>V2 is established, and the voltage V2 is applied to the first conductive impurity region.

3. A display device according to claim 1, wherein
the first conductive impurity region is an n-type impurity region,
a second conductive impurity region is a p-type impurity region,
assuming a voltage applied to the first electrode of the second conductive impurity region as V1 and a voltage which is applied to the second electrode of the second conductive impurity region as V2, the relationship V1>V2 is established, and
the voltage V1 is applied to the first conductive impurity region.

4. A display device according to claim 1, wherein
the drive circuit includes a resistance voltage dividing circuit which generates gray scale reference voltages, and
at least one of resistance elements which constitutes the resistance voltage dividing circuit is constituted of the semiconductor resistance element.

5. A display device according to claim 1, wherein
the drive circuit includes a resistance voltage dividing circuit which generates gray scale reference voltages, and
at least one of respective voltage dividing resistances which constitute the resistance voltage dividing circuit includes a series circuit in which a plurality of semiconductor resistance elements each of which is constituted by connecting switch elements in parallel is connected with each other in series, and
a resistance value of the voltage dividing resistance is varied by controlling the switching elements.

6. A display device according to claim 5, wherein the resistance value of the voltage dividing resistance is varied in conformity with gamma characteristics of red, greed and blue.

7. A display device according to claim 1, wherein
the drive circuit includes a resistance voltage dividing circuit which generates gray scale reference voltages,
at least one of respective voltage dividing resistance which constitutes the resistance voltage dividing circuit has a series circuit in which a plurality of semiconductor resistance elements is connected with each other in series, and
the drive circuit includes a selector which selects one of output voltages outputted from the plurality of semiconductor resistance elements.

8. A display device according to a claim 7, wherein the selector selects one of output voltages outputted from the plurality of semiconductor resistance elements in conformity with gamma characteristics of red, green and blue.

9. A display device according to claim 4, wherein the drive circuit includes a positive-polarity resistance voltage dividing circuit and a negative-polarity resistance voltage dividing circuit.

10. A display device according to claim 9, wherein the semiconductor resistance element is formed on a poly-silicon substrate.
